(19) United States
(12) Patent Application Publication
(10) Pub. No.: US 2019/0188918 A1
(43) Pub. Date: Jun. 20, 2019

(54) SYSTEMS AND METHODS FOR USER SELECTION OF VIRTUAL CONTENT FOR PRESENTATION TO ANOTHER USER

(71) Applicant: Tsunami VR, Inc., Del Mar, CA (US)

(72) Inventors: Beth BREWER, Escondido, CA (US); Kyle PENDERGRASS, San Diego, CA (US)

(21) Appl. No.: 16/221,050

(22) Filed: Dec. 14, 2018

Related U.S. Application Data
(60) Provisional application No. 62/598,841, filed on Dec. 14, 2017.

(51) Int. Cl. G06T 19/00; G06F 3/0481; G06F 3/01

(52) U.S. Cl. CPC G06T 19/006; G06F 3/011; G06F 3/04815

(57) ABSTRACT

Systems, methods, and computer-readable media for user selection of virtual content for presentation in a virtual environment via a first user device and a second user device are provided. The method can include storing information associated with sensitivities of the first user device and sensitivities of the second user device. The sensitivities can indicate one or more conditions at one or more of the first user device and the second user device that affect presentation of portions of the virtual environment. The method can include detecting a selection of content at the first user device for presentation via the second user device, determining if the content can be presented at the second device based on the sensitivities of the second user device and generating a first version of the content that complies with the sensitivities of the second user device.

### CROSS REFERENCE TO RELATED APPLICATIONS

This application claims priority to U.S. Provisional Patent Application Ser. No. 62/598,841, filed Dec. 14, 2017, entitled “SYSTEMS AND METHODS FOR USER SELECTION OF VIRTUAL CONTENT FOR PRESENTATION TO ANOTHER USER,” the contents of which are hereby incorporated by reference in their entirety.

### BACKGROUND

### Technical Field

This disclosure relates to virtual reality (VR), augmented reality (AR), and hybrid reality technologies. More specifically, this disclosure relates to different approaches for user selection of virtual content for presentation to another user using virtual reality (VR), augmented reality (AR), and mixed reality (MR) technologies.

### Related Art

Mixed reality (MR), sometimes referred to as hybrid reality, is the term commonly applied to the merging of real or physical world and virtual worlds to produce new environments and visualizations where physical and digital objects co-exist and interact. Mixed reality visualizations and environments can exists in the physical world, the virtual world, and can include a mix of reality, VR, and AR via immersive technology including interactive environments and interactive three-dimensional (3D) virtual objects. The abbreviation XR may be used to refer generically to VR, AR, and/or MR technologies or processes.

Interactive 3D virtual objects can be complex and contain large amounts of information that describe different features of the virtual objects, including the geometry, appearance, scenery, and animation of the virtual objects. Particular features of a virtual object may include shape, surface geometry, color, texture, material type, light sources, cameras, peripheral objects, animation, physical properties, and kinematics. As virtual objects become more complex by integrating more features, encoding and transferring all features of a virtual object between applications becomes increasingly difficult when multiple files are used to provide details about different features of the virtual object.

Some devices may be limited in their ability to store, render, and display virtual content, or interact with a virtual environment. In some example, these limitations may be based on device capabilities, constraints, and/or permissions.

### SUMMARY

An aspect of the disclosure provides a method for user selection of virtual content for presentation in a virtual environment via a first user device and a second user device. The method can include storing, by a processor, information associated with sensitivities of the first user device and sensitivities of the second user device in a memory coupled to the processor. The sensitivities can indicate one or more conditions at one or more of the first user device and the second user device that affect presentation of portions of the virtual environment. The method can include detecting, at the processor, a selection of content at the first user device for presentation via the second user device. The method can include receiving, at the processor, an instruction to present the content at the second user device. The method can include determining if the content can be presented at the second device based on the sensitivities of the second user device. The method can include generating a first version of the content that complies with the sensitivities of the second user device. The first version can be downconverted or other reduced in resolution for the second user device having more restrictive sensitivities. The first version can be also be upconverted or otherwise increased in resolution or format for the second user device having less restrictive sensitivities or increased capabilities. The method can include transmitting the first version to the second user device.

Another aspect of the disclosure provides a non-transitory computer-readable medium comprising instructions for user selection of virtual content for presentation in a virtual environment via a first user device and a second user device. When executed by one or more processors cause the one or more processors to store information associated with sensitivities of the first user device and sensitivities of the second user device in a memory coupled to the processor. The sensitivities can indicate one or more conditions at one or more of the first user device and the second user device that affect presentation of portions of the virtual environment. The instructions can further cause the one or more processors to detect a selection of content at the first user device for presentation via the second user device. The instructions can further cause the one or more processors to receive an instruction to present the content at the second user device. The instructions can further cause the one or more processors to determine if the content can be presented at the second device based on the sensitivities of the second user device. The instructions can further cause the one or more processors to generate a first version of the content that complies with the sensitivities of the second user device. The instructions can further cause the one or more processors to transmit the first version to the second user device.

Other features and benefits will be apparent to one of ordinary skill with a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1A is a functional block diagram of a system for creating computer-generated virtual environments and providing the virtual environments as an immersive experience for VR, AR and/or MR users;

FIG. 1B is a functional block diagram of a user device for use with the system of FIG. 1A;

FIG. 2 is a flowchart of an embodiment of a method for user selection of virtual content for presentation to another user;

FIG. 3 is a flowchart of an embodiment of a method for implementing portions of the flowchart of FIG. 2; and

FIG. 4 is a flowchart of an embodiment of a method for implementing portions of the flowchart of FIG. 3.

### DETAILED DESCRIPTION

In some implementations of XR (e.g., VR, MR, AR) collaborative tools, a virtual environment can be provided for use by multiple users using different devices, implementing different technology. Some users may have state-of-the-art immersive VR head-mounted devices (HMD) while others may have a smartphone (e.g., AR device). Therefore, certain elements of a given virtual environment may not be viewable by all users in the same way. Some user devices may be limited by processor power or visual display, and thus only be able to view low resolution two dimensional versions of a virtual object as opposed to the full resolution three dimensional version of the same virtual object available via the VR HMD.

This disclosure provides systems, methods, and computer readable media for operations in a collaborative virtual environment. For example, first user can, via an associated user device, select a virtual object for display on the user device of a second user. Based on various conditions, such as user device capabilities and limitations, a first version of the selected virtual object may be displayed via the first while a second, different version of the selected virtual object is transmitted to and displayed via the second user device.

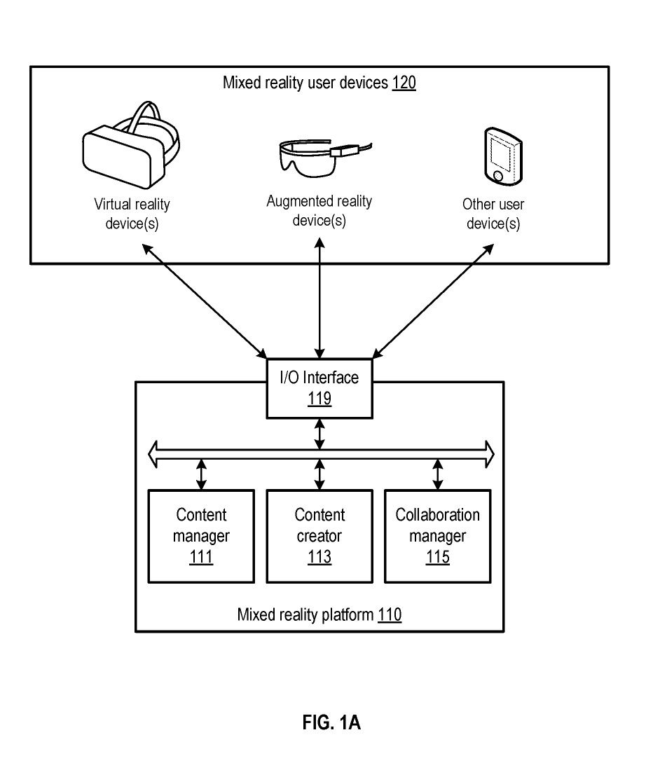

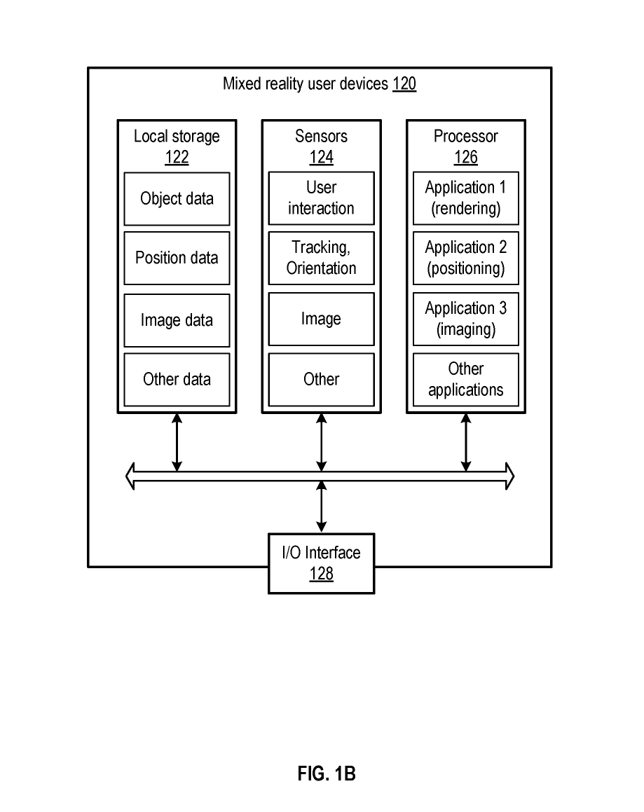

FIG. 1A is a functional block diagram of a system for creating computer-generated virtual environments and providing the virtual environments as an immersive experience for VR, AR and/or MR users. FIG. 1A depict aspects of a system on which different embodiments are implemented for user (via a user device) selection of virtual content for presentation to another user (via another user device). The described system can determine values of conditions experienced by a user, and using the values of the conditions, determine a value of a user permission to apply to the user. The system includes a mixed reality platform 110 that is communicatively coupled to any number of mixed reality user devices 120 such that data can be transferred between them as required for implementing the functionality described in this disclosure. General functional details about the platform 110 and the user devices 120 are discussed below before particular functions involving the platform 110 and the user devices 120 are discussed.

As shown in FIG. 1A, the platform 110 includes different architectural features, including a content manager 111, a content creator 113, a collaboration manager 115, and an input/output (I/O) interface 119. The content creator 113 creates a virtual environment and visual representations of things (e.g., virtual objects and avatars) that can be displayed in a virtual environment depending on a user's point of view. Raw data may be received from any source, and then converted to virtual representations of that data. Different versions of a virtual object may also be created and modified using the content creator 113. The content manager 111 stores content created by the content creator 113, stores rules associated with the content, and also stores user information (e.g., permissions, device type, or other information). The collaboration manager 115 provides portions of a virtual environment and virtual objects to each of the user devices 120 based on conditions, rules, poses (e.g., positions and orientations) of users in a virtual environment, interactions of users with virtual objects, and other information. The I/O interface 119 provides secure transmissions between the platform 110 and each of the user devices 120.

FIG. 1B is a functional block diagram of a user device for use with the system of FIG. 1A. Each of the user devices 120 include different architectural features, and may include the features shown in FIG. 1B, including a local storage 122, sensors 124, processor(s) 126, and an input/output interface 128. The local storage 122 stores content received from the platform 110, and information collected by the sensors 124. The processor 126 runs different applications needed to display any virtual object or virtual environment to a user operating a user device. Such applications include rendering, tracking, positioning, 2D and 3D imaging, and other functions. The I/O interface 128 from each user device 120 manages transmissions between that user device 120 and the platform 110. The sensors 124 may include inertial sensors that sense movement and orientation (e.g., gyros, accelerometers and others), optical sensors used to track movement and orientation, location sensors that determine position in a physical environment, depth sensors, cameras or other optical sensors that capture images of the physical environment or user gestures, audio sensors that capture sound, and/or other known sensor(s). Depending on implementation, the components shown in the user devices 120 can be distributed across different devices (e.g., a worn or held peripheral separate from a processor running a client application that is communicatively coupled to the peripheral). Examples of such peripherals include head-mounted displays, AR glasses, and other peripherals.

Some of the sensors 124 (e.g., inertial, optical, and location sensors) are used to track the pose (e.g., position and orientation) of a user in virtual environments and physical environments. Tracking of user position and orientation (e.g., of a user head or eyes) is commonly used to determine view areas, and the view area is used to determine what virtual objects to render using the processor 126 for presentation to the user on a display of a user device. Tracking the positions and orientations of the user or any user input device (e.g., a handheld device) may also be used to determine interactions with virtual objects. In some embodiments, an interaction with a virtual object includes a modification (e.g., change color or other) to the virtual object that is permitted after a tracked position of the user or user input device intersects with a point of the virtual object in a geospatial map of a virtual environment, and after a user-initiated command is provided to make the desired modification. Positions in a physical environment may be tracked in different ways, including positioning using Global Navigation Satellite Systems (GNSS), Bluetooth, WiFi, an altimeter, or any other known way to estimate the position of a thing (e.g., a user) in a physical environment.

Some of the sensors 124 (e.g., cameras and other optical sensors of AR devices) may also be used to capture information about a physical environment, which is used to generate virtual representations of that information, or to generate geospatial maps of the physical environment that can be used to determine where and how to present virtual objects among physical objects of the physical environment. Such virtual representations and geospatial maps may be created using any known approach. In one approach, many two-dimensional images are captured by a camera of an AR device, those two-dimensional images are used to identify three-dimensional points in the physical environment, and the three-dimensional points are used to determine relative positions, relative spacing and structural characteristics (e.g., surfaces and depths) of physical objects in the physical environment. Other optical sensors may be used in addition to a camera (e.g., a depth sensor). Textures, colors and other features of physical objects or physical environments can be determined by analysis of individual images.

Examples of the user devices 120 include VR, AR, MR and general computing devices with displays, including head-mounted displays, sensor-packed wearable devices with a display (e.g., glasses), mobile phones, tablets, desktop computers, laptop computers, or other computing devices that are suitable for carrying out the functionality described in this disclosure.

The methods or processes outlined and described herein and particularly those that follow below, can be performed by one or more processors of the platform 110 either alone or in connection or cooperation with the user device(s) 120. The processes can also be performed using distributed or cloud-based computing. In addition, the platform 110 can perform processes including determining values of conditions experienced at the user device 120, and determine a value of one or more user permissions to apply to one or more user devices based on the values of those conditions.

### User Selection of Virtual Content for Presentation to Another User

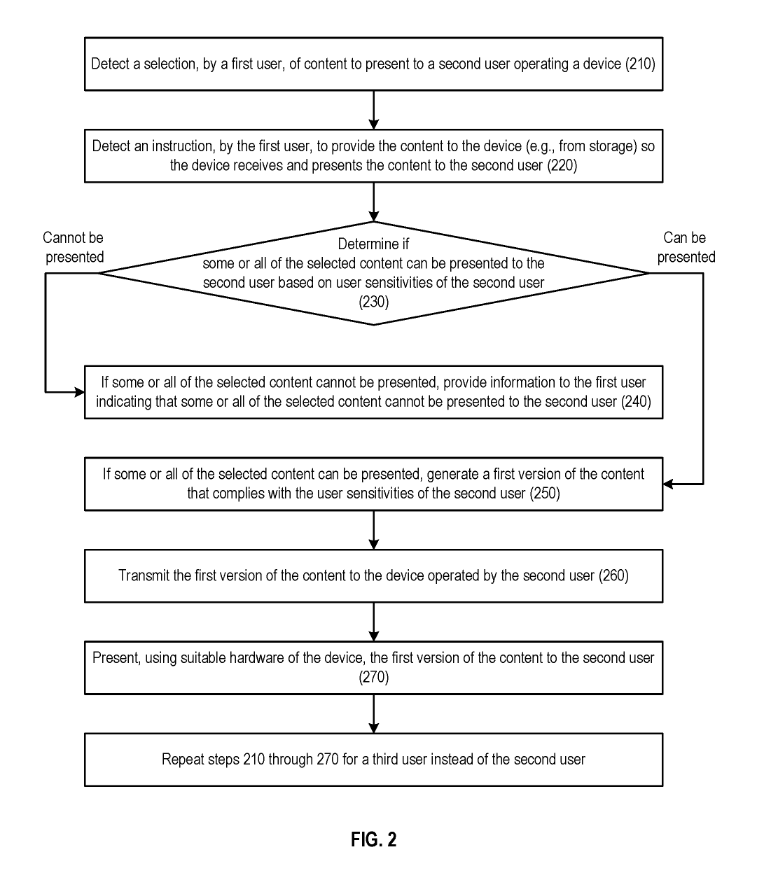

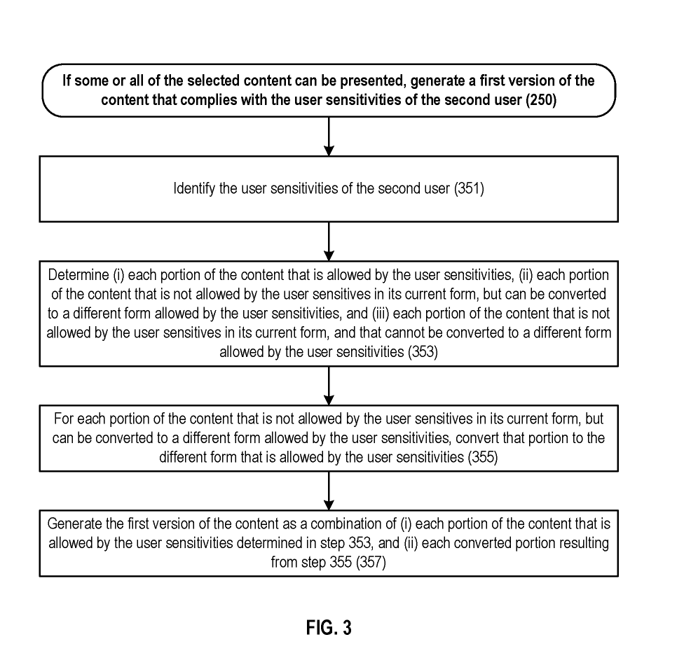

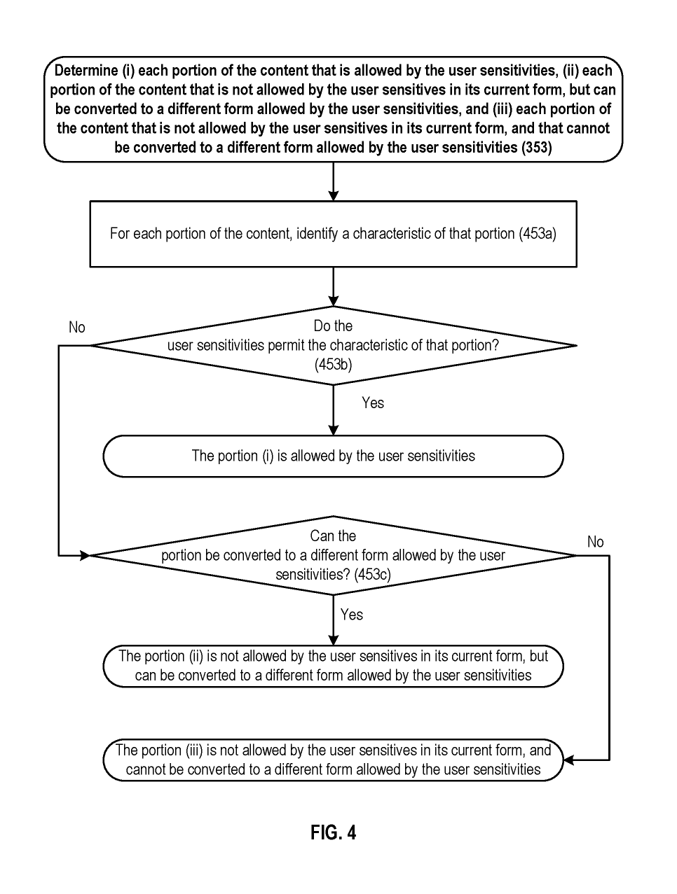

FIG. 2 is a flowchart of an embodiment of a method for user selection of virtual content for presentation to another user. The steps of the following methods of FIG. 2, FIG. 3, and FIG. 4 may be performed by the platform 110 and the user device 120, either alone or cooperatively. Various steps may be described in terms of “user” actions, however, the functions are performed by the associated electronic components (e.g., user device 120, the platform 110, or one or more associated processors).

The platform 110 can host or otherwise provide a collaborative virtual environment for a plurality of users via a respective plurality of user devices. The plurality of users can interact with the virtual environment and with each other simultaneously via their respective user devices 120. Accordingly, multiple users can participate in the same virtual environment simultaneously irrespective of being a VR, AR, or MR user. A first user, also referred to as a controlling user, can select content within the virtual environment for display to a second user via a second user device 120. However, in some exemplary situations, users may be operating within the virtual environment using different or incompatible user devices having one or more limitations or sensitivities related to the virtual environment, the content, or to each other. For example, one user device 120 can have VR capabilities, while another has AR functions, and still a third has MR capabilities (or any combination thereof). Some may be able to easily render virtual content in three dimensions, while others only two dimensions, or be limited by bandwidth or system degradations.

The following are non-limiting examples to aid understanding of the disclosed methods for in the collaborative XR environment described herein. In one example, a first user using a VR device may desire to collaborate with a second user using an AR device. In such an example, (the originator is VR user) the system can provide a virtual representation of the first user's virtual environment and associated data, including the avatar of the first user. The virtual representation can: (1) be the same size as the originator's virtual world or (2) can be a miniature size that the AR user could grab objects from to view.

In other words, the AR user device can display, for example, virtual objects (of the virtual environment) overlaid on the physical space, or real world. The VR user device can immerse the user in the virtual environment with no view of the physical world. In the event the VR user (e.g., the first user) is controlling the collaboration, the first user may select all of the virtual content for display at the AR user device. It can be presented in several ways: (1) the virtual objects can be displayed as a list to the AR user that can then pick from the list for display to the AR user; (2) the AR user can view a miniature version of the virtual environment (e.g., the VR space of the VR user) and select virtual objects for view; (3) the AR user view the same size version of the virtual objects overlaid in the physical space (assuming the physical space is large enough); and/or (4) the VR user can select which objects that the AR user can view one at a time. In these examples, the AR user views what the VR user directs the system to present to the AR user. Alternatively, the platform 110 can further make determinations of what can be viewed by the AR user based on any physical limitations of AR user's physical space.

In another example, if an AR user (e.g., the first user) is controlling a collaboration with a VR user, the AR user may select virtual objects for the VR user to view in the associated virtual environment, or virtual representations of the physical space associated with the AR user.

The method of FIG. 2 can, for example, provide a process for the platform 110, for example, to determine how to present the virtual content/objects and/or the virtual environment based on either the user preference, system limitations, or one or more predefined rules.

As shown in FIG. 2, the selection, by the first user via the user device 120, of content from a first environment to present to the second user operating a device is detected (210)—e.g., the first user selects content (as selected content) from a virtual environment in view of the first user using a selection action. Examples of selection actions by the first user include pressing a button of a handheld tool when a virtual beam from a virtual image of the tool intersects the content or an indicator of the content in the virtual environment, making a gesture that identifies the content in the virtual environment, making a voice command, directing the first user's eyes towards the content or an indicator of the content shown to the first user on a display, or other actions that are recognizable as selection actions. In some embodiments, the platform 110 can detect the selection.

An instruction, by the first user via the associated user device, to provide the content to the device of the second user (e.g., from storage of the platform 110) so the device of the second user receives and presents the content to the second user is detected (220). Examples of instructions include (i) moving the selected content or an indicator of the content in the virtual environment so it intersects with an avatar representing the second user, an area around the avatar, a virtual object, or other thing associated with the second user in the virtual environment, and (ii) then providing an input (e.g., releasing or pressing of the button, making of another gesture, making a voice command, or other action) that confirms the first user's desire to present the content to the second user. One example of the instruction is dragging (e.g., moving) and dropping (e.g., releasing a button, making a gesture, making a voice command) the content onto the avatar that represents the second user in the virtual environment.

An optional determination is made as to whether some or all of the selected content can be presented to the second user based on user sensitivities of the second user (230). Sensitivities can include features or capabilities that limit or otherwise restrict the operability of a given user device 120 within a virtual environment. Such sensitivities or limitations can to include the technology supported by a display (e.g., I/O interface 128) of the user device 120, by the software or operating system of the user device 120, one or more states or conditions of the device or software, of other features. Examples of user sensitivities can include an indicator that video content can or cannot be presented to the second user, an indicator that audio content can or cannot be presented to the second user (e.g., a speaker is turned off, or volume is below a threshold level), an indicator that text content can or cannot be presented to the second user, an indicator that three-dimensional object(s) in content can or cannot be presented to the second user (e.g., a display of the device is two-dimensional), an indicator that feedback can or cannot be received from the second user (e.g., inputs of the device are unavailable), an indicator of a data rate available to the device of the second user, an indicator of a processing capability available to the device of the second user, and/or an indicator of a permission level of the second user. The indicators may be determined based on the capabilities of the second user's device, status of one or more hardware/firmware/software components of the second user's user device 120, or based on preferences of the second user. Information related to or associated with the sensitivities of user devices can be stored in a memory. The memory can be a local memory, a cloud-based memory, or a distributed memory spread across multiple devices.

If, after step 230, some or all of the selected content cannot be presented, information is provided to the first user indicating that some or all of the selected content cannot be presented to the second user (240). Such information can be provided by the platform 110 to the first user or directly from the second user to the first user.

If, after step 230, some or all of the selected content can be presented, a first version of the content that complies with the user sensitivities of the second user is generated (250). One implementation of step 250 is shown in FIG. 3. The first version may be modified or otherwise converted from the version viewed by the first user to comply with sensitivities or other limitations of the second user or second user device. For example, a 3D virtual object (selected by the VR user) may be converted to a 2D virtual object for viewing on an AR display (of the AR user device) or vice versa. Such modifications can include a reduction in quality, resolution, or features if selected by a more capable first user device for viewing by a less capable second user device. In other examples, the modifications can include an increase in quality, resolution, or features if selected by a less capable first user device for viewing by a more capable second device.

As described herein, the platform 110 can provide the VR environment including selected versions of the same virtual object for display on multiple user devices simultaneously based on the capabilities of the various user devices. Thus, for ease of description the terms “convert” or “modify” are used to describe that a 3D virtual object displayed via a VR user device can, for example, be selected for viewing as a 2D version of the same virtual object via an AR device. Accordingly, the objects may not necessarily be “converted” or “modified” from one version of the virtual environment to another; the platform 110 may provide one version or another based on sensitivities, user device limitations, or various system or connectivity degradations.

The first version of the content is transmitted to the device operated by the second user (260).

Using suitable hardware (e.g., display, speaker, lights, haptic component, or other output) of the device, the first version of the content is presented to the second user (270). The first version may be presented to the user as any user would see that version. Alternatively, the first version may be presented based on the viewpoint of the second user in the virtual environment relative to the position of the content.

In some embodiments, steps 210 through 270 are repeated for a third user instead of the second user.

In some embodiments, the steps 250, 260, 270 can, for example, include automatically displaying virtual content selected at the controlling or first user device based on one or more behaviors (e.g., movement of a tool, use of a virtual device). Selection of virtual content by a controlling user device can be based on a user interaction with a device or tool. In one example, if a user is actively writing on a virtual whiteboard, that whiteboard can appear for the other collaborating users. In such an example, a VR user may be writing on the whiteboard. Other VR users may be able to see the entire VR environment, including the virtual whiteboard. However, an AR user or MR user may be limited by a 2D display and not be able to continuously see or experience the entire view of the virtual environment due to limitations or sensitivities of the AR or MR user devices. The act of writing on the virtual whiteboard can be a sufficient trigger to “select” the virtual whiteboard for display via other collaborating user devices. When the user stops interacting with the whiteboard, the whiteboard may disappear from the AR/MR user devices (e.g., after a predetermined or selected period of time). In another embodiment, the VR user can select which objects from the virtual space to appear in the physical space of the AR/MR users.

### Implementation of Step 250 of FIG. 2

FIG. 3 is a flowchart of an embodiment of a method for implementing portions of the flowchart of FIG. 2. For example, the method of FIG. 3 can be used to perform step 250 of FIG. 2, which generates a first version of the content that complies with the user sensitivities of the second user if some or all of the selected content can be presented (250).

As shown in FIG. 3, the user sensitivities of the second user are identified (351).

Different portions of the content may be identified (e.g., video, audio, text, three-dimensional images, feedback requested, or other portions). For each identified portion of the content, a determination is made as to whether that portion is (i) allowed by the user sensitivities, (ii) not allowed by the user sensitives in its current form, but can be converted to a different form allowed by the user sensitivities, or (iii) not allowed by the user sensitives in its current form, and cannot be converted to a different form allowed by the user sensitivities (353). One implementation of step 353 is shown in FIG. 4. As used herein, the content that is (ii) not allowed by the user sensitives in its current form, but can be converted to a different form allowed by the user sensitivities may be referred to as convertible content. The content that is not allowed by the user sensitives in its current form, and cannot be converted to a different form allowed by the user sensitivities may be referred to as unpresentable content.

For each portion of the content that is not allowed by the user sensitives in its current form, but can be converted to a different form allowed by the user sensitivities, that portion is converted to the different form that is allowed by the user sensitivities (355). Examples of converting disallowed portions to different forms respectively include: converting disallowed audio to text; converting disallowed text to audio; converting disallowed video to descriptive audio/text, or still images of the disallowed video; and/or converting disallowed three-dimensional object(s) to two-dimensional image(s) of the object(s).

In some examples, the conversion of convertible content that complies with user sensitivities can include downconverting or otherwise reducing the resolution of a given virtual object or flattening a 3D virtual object to 2D for display via an two dimensional or AR user device. Such an example can include a VR user selecting a 3D virtual object for display via a AR user device. On a larger scale, this can further include converting a virtual environment, including the virtual object(s), data, and avatars of the VR user (and other collaborating users/user devices) into a virtual object that can be displayed on the AR user device, or overlaid on the physical environment for display via the AR user device.

In the opposite arrangement, a less capable device can select content for view on a more capable device (e.g., a device with fewer sensitivities). For example, if an AR user selects (via the user device 120) 2D content for display at a more capable VR user device 120, then the 2D virtual content may be upconverted (e.g., in resolution), or rendered and displayed as a 3D version of the 2D content at the VR user device. In some other examples, an AR user device can scan or otherwise map a surrounding physical environment and provide such a map for display as a virtual version of the physical environment at the (collaborating) VR user device. This can include providing sufficient mapping information associated with the surrounding physical environment (e.g., real world) to form a 3D map of the physical environment. The AR (or MR) device (e.g., the user device 120) can provide the 3D mapping information directly to the VR user device for rendering the 3D, virtual version of the physical environment (e.g., real world). In another example, the platform 110 can use the 3D mapping information (from the AR user device) to render a virtual version of the physical environment for display at the more capable VR user device 120. Accordingly, the first user can select one or more aspects of the surrounding physical (AR/MR) or virtual (VR) environment for rendering or conversion and display at one or more collaborating user devices.

The first version of the content is generated as a combination of (i) each portion of the content that is allowed by the user sensitivities determined in step 353, and (ii) each converted portion resulting from step 355 (357).

### Implementation of Step 353 of FIG. 3

FIG. 4 is a flowchart of an embodiment of a method for implementing portions of the flowchart of FIG. 3. For example, the method of FIG. 4 can be used to perform step 353 of FIG. 3, which determines (i) each portion of the content that is allowed by the user sensitivities, (ii) each portion of the content that is not allowed by the user sensitivities in its current form, but can be converted to a different form allowed by the user sensitivities, and (iii) each portion of the content that is not allowed by the user sensitives in its current form, and that cannot be converted to a different form allowed by the user sensitivities.

For each portion of the content, a characteristic of that portion is identified (453a). Examples of characteristics include: video content; audio content; text content; three-dimensional object(s); a request for feedback from the consuming user (e.g., the second user to which content is to be presented); a required data rate for receiving the portion; a required processing capability for presenting the portion; a permission level of the consuming user required for consuming the portion; and/or another characteristic. Identifying the characteristic can be accomplished using know techniques (e.g., correlating a file extension of the portion to the characteristic, looking up the characteristic, or otherwise detecting the characteristic).

As shown in FIG. 4, a determination is made as to whether the user sensitivities permit the characteristic of that portion (453b). In one implementation of step 453b, the determination is carried out by comparing the identified characteristic with a list of characteristics of or associated with the user sensitivities. Examples of determinations include identification of reduced capabilities or higher sensitivities at the user device: video is not permitted when the user sensitivities include an indicator that video content cannot be presented (e.g., when the device has no display, or the display is in use for other content); audio is not permitted when the user sensitivities include an indicator that audio content cannot be presented (e.g., when the device has no speaker, a speaker of the device is turned off, or the volume level of the device is below a threshold); text is not permitted when the user sensitivities include an indicator that text content cannot be presented (e.g., when the device has no display, or when the display setting of the device does not permit text such as when the display is in use for other content); three-dimensional portioned content is not permitted when the user sensitivities include an indicator that three-dimensional portioned content cannot be presented (e.g., when the device has no three-dimensional display); feedback is not permitted when the user sensitivities include an indicator that feedback cannot be received (e.g., when the device has no inputs necessary to generate or capture feedback from the user); content requiring a particular data rate for presenting that content is not permitted when the user sensitivities include an indicator that the data rate available to the device is below the particular data rate (e.g., based on network connection speed and/or maximum load available to the device for receiving the content); content requiring a particular processing capability for presenting that content is not permitted when the user sensitivities include an indicator that the processing capability available to the device is below the particular processing capability (e.g., based on known limits of processors in the device, or current processing load experienced by the processors); and/or content requiring a particular permission level for presenting the content is not permitted when the user sensitivities include an indicator that the permission level of the second user does not meet or exceed the particular permission level.

The determination at step 435b can also include identification of increased capabilities or lower sensitivities at the destination or second user device. For example, if the an AR-capable device selected 2D virtual content for display, and the destination or second user device is VR-capable, the resolution or format can be upconverted or converted into higher resolution or 3D content for the VR-capable user device. In another example, if the second user device simply has more capabilities (e.g., a speaker or other components not present on the first user device) than the first user device, audio may be added or video may be included. Accordingly, the opposite processes from those enumerated above can be performed for a second user device having fewer or less restrictive sensitivities than the first user device. In some examples, this can include converting text to audio, converting or reformatting descriptive audio or text video into video, converting still images into video, and converting two-dimensional images of the object into a three-dimensional object.

If, after step 453b, the user sensitivities permit the characteristic of that portion, a determination is made that the portion (i) is allowed by the user sensitivities.

If, after step 453b, the user sensitivities do not permit the characteristic of that portion, a determination is made as to whether the portion can be converted to a different form allowed by the user sensitivities (453c).

If, after step 453c, the portion can be converted to a different form allowed by the user sensitivities, a determination is made that the portion (ii) is not allowed by the user sensitives in its current form, but can be converted to a different form allowed by the user sensitivities. In general, the different form can be a higher resolution or a lower resolution, upconverted or down converted.

If, after step 453c, the portion cannot be converted to a different form allowed by the user sensitivities, a determination is made that the portion (iii) is not allowed by the user sensitives in its current form, and cannot be converted to a different form allowed by the user sensitivities. Examples of characteristics that are not allowed by the user sensitives regardless of form in may include: requested feedback that is not possible using the device of the user (e.g., user sensitivities indicate the user device has no input capabilities); a required data rate for receiving the portion that is not possible using the device of the user (e.g., user sensitivities indicate the connection of the user device is not equal to or greater than the required data rate); a required processing capability for presenting the portion that is not possible using the device of the user (e.g., user sensitivities indicate the processing capability of the user device is not equal to or greater than the required processing capability); and/or a permission level of the consuming user required for consuming the portion that is not possible (e.g., user sensitivities indicate the permission level of the user is not equal to or greater than the permission level for consuming the portion).

### Other Aspects

Each method of this disclosure can be used with virtual reality (VR), augmented reality (AR), and/or mixed reality (MR) technologies.

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed.

By way of example, machines may include one or more computing device(s), processor(s), controller(s), integrated circuit(s), chip(s), system(s) on a chip, server(s), programmable logic device(s), other circuitry, and/or other suitable means described herein (e.g., the platform 110, the user device 120) or otherwise known in the art. Systems that include one or more machines or the one or more non-transitory machine-readable media embodying program instructions that, when executed by the one or more machines, cause the one or more machines to perform or implement operations comprising the steps of any methods described herein are also contemplated.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Systems comprising one or more modules that perform, are operable to perform, or adapted to perform different method steps/stages disclosed herein are also contemplated, where the modules are implemented using one or more machines listed herein or other suitable hardware. When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

What is claimed is:

1. A method for user selection of virtual content for presentation in a virtual environment via a first user device and a second user device, the method comprising:
storing, by a processor, information associated with sensitivities of the first user device and sensitivities of the second user device in a memory coupled to the processor, the sensitivities indicating one or more conditions at one or more of the first user device and the second user device that affect presentation of portions of the virtual environment;
detecting, at the processor, a selection of content at the first user device for presentation via the second user device;
receiving, at the processor, an instruction to present the content at the second user device;
determining if the content can be presented at the second device based on the sensitivities of the second user device;
generating a first version of the content that complies with the sensitivities of the second user device; and
transmitting the first version to the second user device.

2. The method of claim 1 further comprising:
indicating to the first user device that at least a first portion of the content cannot be presented to the second user if the at least a first portion of the content cannot be presented to the second user device based on the sensitivities of the second user device; and
generating the first version of the content that complies with the sensitivities of the second user device if at least a second portion of the content complies with the sensitivities.

3. The method of claim 1 further comprising:
identifying the sensitivities of the second user device;
identifying each presentable portion of the content that is presentable at the second user device based on the sensitivities of the second user device;
identifying each convertible portion of the content that is not presentable in its current form at the second user device based on the sensitivities of the second user device, but can be converted to a presentable form compliant with the user sensitivities of the second user device;
identifying each convertible portion of the content that can be presented in a higher resolution or format at the second user device based on less restrictive sensitivities than at the second user device than at the first user device;
converting each convertible portion of the content to the presentable form that is compliant with the user sensitivities (355); and
generating the first version of the content as a combination of each presentable portion, and each convertible portion.

4. The method of claim 3 further comprising identifying each unpresentable portion of the content that is not presentable in its current form at the second user device based on the sensitives, and cannot be converted to a presentable form compliant with the user sensitivities of the second user device.

5. The method of claim 3 wherein the converting comprises at least one of:
converting disallowed audio into text;
converting disallowed text into audio;
converting disallowed video into descriptive audio/text;
converting disallowed video into still images; and
converting a disallowed three-dimensional object into two-dimensional images of the object.

6. The method of claim 1 wherein the sensitivities of the second user device comprise an indicator of whether the second user device can record or playback audio.

7. The method of claim 1 wherein the sensitivities of the second user device comprise an indicator of whether the second user device can display three dimensional virtual content.

8. The method of claim 1 wherein the sensitivities comprise a condition of one or more hardware components of the second user device.

9. The method of claim 1 wherein the sensitivities comprise a user preference of the second user device.

10. A non-transitory computer-readable medium comprising instructions for user selection of virtual content for presentation in a virtual environment via a first user device and a second user device, that when executed by one or more processors cause the one or more processors to:
store information associated with sensitivities of the first user device and sensitivities of the second user device in a memory coupled to the processor, the sensitivities indicating one or more conditions at one or more of the first user device and the second user device that affect presentation of portions of the virtual environment;
detect a selection of content at the first user device for presentation via the second user device;
receive an instruction to present the content at the second user device;
determine if the content can be presented at the second device based on the sensitivities of the second user device;
generate a first version of the content that complies with the sensitivities of the second user device; and
transmit the first version to the second user device.

11. The non-transitory computer-readable medium of claim 10 further comprising instructions to cause the one or more processors to:
indicate to the first user device that at least a first portion of the content cannot be presented to the second user if the at least a first portion of the content cannot be presented to the second user device based on the sensitivities of the second user device; and
generate the first version of the content that complies with the sensitivities of the second user device if at least a second portion of the content complies with the sensitivities.

12. The non-transitory computer-readable medium of claim 10 further comprising instructions to cause the one or more processors to:
identify the sensitivities of the second user device;
identify each presentable portion of the content that is presentable at the second user device based on the sensitivities of the second user device;
identify each convertible portion of the content that is not presentable in its current form at the second user device based on the sensitivities of the second user device, but can be converted to a presentable form compliant with the user sensitivities of the second user device;
convert each convertible portion of the content to the presentable form that is compliant with the user sensitivities (355); and
generate the first version of the content as a combination of each presentable portion, and each convertible portion.

13. The non-transitory computer-readable medium of claim 12 further comprising instructions to cause the one or more processors to identify each unpresentable portion of the content that is not presentable in its current form at the second user device based on the sensitives, and cannot be converted to a presentable form compliant with the user sensitivities of the second user device.

14. The non-transitory computer-readable medium of claim 12 wherein the converting comprises at least one of:
converting disallowed audio into text;
converting disallowed text into audio;
converting disallowed video into descriptive audio/text;
converting disallowed video into still images; and
converting a disallowed three-dimensional object into two-dimensional images of the object.

15. The non-transitory computer-readable medium of claim 10 wherein the sensitivities of the second user device comprise an indicator of whether the second user device can record or playback audio.

16. The non-transitory computer-readable medium of claim 10 wherein the sensitivities of the second user device comprise an indicator of whether the second user device can display three dimensional virtual content.

17. The non-transitory computer-readable medium of claim 10 wherein the sensitivities comprise a condition of one or more hardware components of the second user device.

18. The non-transitory computer-readable medium of claim 10 wherein the sensitivities comprise a user preference of the second user device.
